(19) United States
(12) Patent Application Publication
(10) Pub. No.: US 2023/0335865 A1
(43) Pub. Date: Oct. 19, 2023

(54) Cylindrical Cell and Battery Module

(71) Applicant: JIANGSU ZENERGY BATTERY TECHNOLOGIES CO., LTD, Jiangsu (CN)

(72) Inventors: Zhikang WU, Jiangsu (CN); Shengli CHEN, Jiangsu (CN); Yongjun LI, Jiangsu (CN); Fawen LIN, Jiangsu (CN); Ruipeng ZHANG, Jiangsu (CN)

(21) Appl. No.: 18/133,360

(22) Filed: Apr. 11, 2023

(30) Foreign Application Priority Data
Apr. 11, 2022 (CN) 202210371648.4
Jun. 7, 2022 (CN) 202210636265.5
Feb. 6, 2023 (CN) 202310068555.9

(51) Int. Cl. H01M 50/477; H01M 50/184; H01M 50/107; H01M 50/152

(52) U.S. Cl. CPC H01M 50/477; H01M 50/107; H01M 50/152; H01M 50/184

(57) ABSTRACT

Disclosed are a cylindrical battery and a battery module. The cylindrical battery includes: a housing; a cell arranged in the housing, where the cell is provided with a first tab, and a second tab having an opposite polarity relative to the first tab, and the first tab and the second tab are located at the same end face of the cell; a cover assembly connected to the housing, where the cover assembly includes a first cover, a second cover and an insulator, the first cover and the second cover are connected to each other in an insulated manner through the insulator to form an integral structure, the first cover is connected to the first tab, and the second cover is connected to the second tab; and an insulating barrier arranged between the first tab and the second tab.

### CROSS-REFERENCE TO RELATED APPLICATION

The disclosure claims priority to Chinese Patent Application No. 202210371648.4, filed to the China National Intellectual Property Administration on Apr. 11, 2022 and entitled “Cylindrical Battery and Battery Pack”, further the disclosure claims priority to Chinese Patent Application No. 202210636265.5, filed to the China National Intellectual Property Administration on Jun. 07, 2022 and entitled “Cylindrical Battery and Battery Module”, further the disclosure claims priority to Chinese Patent Application No. 202310068555. 9, filed to the China National Intellectual Property Administration on Feb. 06, 2023 and entitled “Cylindrical Battery and Battery Module” which are incorporated herein by reference in its entirety.

### TECHNICAL FIELD

The disclosure relates to the technical field of batteries and battery manufacturing, in particular to a cylindrical battery and a battery module.

### BACKGROUND

A lithium battery includes lithium (including metal lithium, lithium alloy, lithium ions and lithium polymers) in an electrochemical system. With a small size, a large capacity, a long service life, a low self-discharge rate, no memory effect, environmental protection, etc., it has been extensively used in commercial and special vehicles, electric bicycles, energy storage systems, medical devices, etc.

Positive and negative tabs of the existing battery may be led out from two ends of a cell, or arranged at the same end face of the cell. However, they get close relatively in the second housing, and are likely to touch each other, which inevitably results in a short circuit of the battery.

### SUMMARY

One objective of the disclosure is to provide a cylindrical battery that may prevent a short circuit of the battery due to contact between a positive tab and a negative tab located at the same end face of a cell.

In order to achieve the above objective, the disclosure uses the following technical solution:

A cylindrical battery includes:
a housing;
a cell arranged in the housing, where the cell is provided with a first tab, and a second tab having an opposite polarity relative to the first tab, and the first tab and the second tab are located at the same end face of the cell;
a cover assembly connected to the housing, where the cover assembly includes a first cover, a second cover and an insulator, the first cover and the second cover are connected to each other in an insulated manner through the insulator to form an integral structure, the first cover is connected to the first tab, and the second cover is connected to the second tab; and
an insulating barrier arranged between the first tab and the second tab.

In an embodiment of the disclosure, the insulating barrier includes a first connection portion and a second connection portion, the first connection portion is arranged perpendicular to the second connection portion, one end of the first connection portion is connected to the second connection portion, one end of the second connection portion extends in the x direction towards the first tab to form a space for accommodating the first tab, and the other end of the second connection portion extends in the y direction towards the second tab to form a space accommodating the second tab.

In an embodiment of the present inventiondisclosure, the second connection portion is provided with a first bayonet and a second bayonet on two sides of the first connection portion, the first tab is in clamped connection to the first bayonet, and the second tab is in clamped connection to the second bayonet.

In an embodiment of the present inventiondisclosure, the second connection portion is made of a high-temperature resistant material.

In an embodiment of the present inventiondisclosure, two ends of the first connection portion are provided with reinforcement structures.

In an embodiment of the present inventiondisclosure, each of the reinforcement structures is arranged in a cambered shape.

In an embodiment of the present inventiondisclosure, the first connection portion and the second connection portion are in a split structure or an integral structure.

In an embodiment of the present inventiondisclosure, the bottom of the insulator is provided with an accommodation groove, and the other end of the first connection portion is arranged in the accommodation groove.

In an embodiment of the present inventiondisclosure, the insulator and the first connection portion are in an integral structure.

In an embodiment of the present inventiondisclosure, a surface, connected to the insulator, of the first cover and/or the second cover is provided with a plurality of nanopores, and the insulator is partially embedded in the plurality of nanopores.

In an embodiment of the present inventiondisclosure, an insulating seal is arranged between the housing and the cover assembly.

In an embodiment of the present inventiondisclosure, the insulating seal and the insulator are integrally formed.

Another objective of the disclosure is to provide a battery module that includes a plurality of cylindrical batteries as described in the above description.

Compared with the related art, the disclosure has the following beneficial effects:

According to the cylindrical battery, the housing, the cell, the cover assembly and the insulating barrier are used in cooperation, the cell is provided with the first tab, and the second tab having the opposite polarity relative to the first tab, the first tab and the second tab are located at the same end face of the cell, the cover assembly includes the first cover, the second cover and the insulator, the first cover is connected to the first tab, the second cover is connected to the second tab, the first cover and the second cover are connected to each other in an insulated manner through the insulator, the short circuit of the battery due to contact between the first tab and the second tab is effectively prevented, and the insulating barrier is arranged between the first tab and the second tab, thereby effectively isolating the first tab from the second tab. The short circuit of the battery due to contact between the first tab and the second tab located at the same end face of the cell is prevented, and safety of the battery is effectively improved.

Additional aspects and advantages of the disclosure will be set forth partially in the following description, which will become partially apparent in the following description, or may be learned through implementation of the disclosure.

### BRIEF DESCRIPTION OF THE DRAWINGS

To describe technical solutions in embodiments of the disclosure or in the related art more clearly, accompanying drawings required in description of the embodiments or in the related art will be briefly introduced below. Apparently, the accompanying drawings in the following description merely show some embodiments of the disclosure, and a person of ordinary skill in the art may still derive other accompanying drawings from these accompanying drawings without creative efforts.

FIG. 1 is a first schematic exploded view of a battery block according to the disclosure;

FIG. 2 is a second schematic exploded view of a battery block according to the disclosure;

FIG. 3 is a schematic structural diagram according to the disclosure;

FIG. 4 is a schematic diagram of an exploded structure according to the disclosure;

FIG. 5 is a first schematic diagram of a sectional structure according to the disclosure;

FIG. 6 is an enlarged view of portion A in FIG. 5;

FIG. 7 is a second schematic diagram of a sectional structure according to the disclosure;

FIG. 8 is an enlarged view of portion B in FIG. 7;

FIG. 9 is a third schematic diagram of a sectional structure according to the disclosure;

FIG. 10 is an enlarged view of portion C in FIG. 9;

FIG. 11 is a first schematic structural diagram of an insulating barrier according to the disclosure;

FIG. 12 is a second schematic structural diagram of an insulating barrier according to the disclosure;

FIG. 13 is a schematic diagram of a housing according to the disclosure;

FIG. 14 is a schematic structural diagram of a cell according to the disclosure;

FIG. 15 is a schematic structural diagram of a cover assembly according to the disclosure;

FIG. 16 is another schematic structural diagram according to the disclosure;

FIG. 17 is a schematic structural diagram of portion D in FIG. 16; and

FIG. 18 is a schematic structural diagram of a top view according to the disclosure.

### REFERENCE NUMERALS

100. housing; 110. flange portion; 120. crimping portion; 130. side wall; 140. bottom wall;
200. cover assembly; 210. first cover; 220. second cover; 230. insulator; 232. bump;
300. cell; 310. first tab; 320. second tab;
400. insulating barrier; 410. first connection portion; 411. reinforcement structure; 412. accommodation groove; 420. second connection portion; 421. first bayonet; 422. second bayonet;
500. insulating seal;
600. x direction;
700. y direction;
800. battery module; and 810. box.

### DETAILED DESCRIPTION OF THE EMBODIMENTS

Embodiments of the disclosure will be further described below in detail with reference to accompanying drawings and in conjunction with embodiments. The following detailed description of the embodiments and the accompanying drawings are configured to illustratively describe principles of the disclosure, rather than limit the scope of the disclosure, that is, the disclosure is not limited to the described embodiments.

In the description of the disclosure, it should be noted that, unless otherwise specified, “plurality” means two or more, the orientation or positional relationships indicated by the terms “up”, “down”, “left”, “right”, “inside”, “outside”, etc. are merely used for facilitating the description of the disclosure and simplification of the description, rather than indicating or implying that an apparatus or an element referred to must have a particular orientation or be constructed and operated in a particular orientation, and therefore will not be constructed as limitation to the disclosure. In addition, the terms “first”, “second”, etc. are merely used for describing purposes and cannot be understood as indicating or implying relative importance.

In the description of the disclosure, it should be noted that, unless otherwise explicitly specified and defined, the terms “mounting”, “connecting”, and “connection” should be understood in a broad sense, for embodiment, they are a fixed connection, a detachable connection, or an integrated connection; and are a direct connection, or an indirect connection via an intermediate medium. For those of ordinary skill in the art, specific meanings of the above terms in the disclosure are understood according to specific circumstances.

In the disclosure, a battery includes a lithium-ion secondary battery, a lithium-ion primary battery, a lithium-sulfur battery, a sodium lithium-ion battery, a sodium ion battery, a magnesium ion battery, etc., which is not limited by the embodiments of the disclosure.

A battery module 800 mentioned in the embodiment of the disclosure refers to a single physical module that includes one or more batteries and therefore provides a higher voltage and capacity. For embodiment, the battery module 800 mentioned in the disclosure includes a battery block, a battery pack, etc. Generally, the battery module 800 includes a box 810 for packaging one or more batteries. The box 810 may prevent a liquid or other foreign matters from affecting charging or discharging of the battery.

For development of battery technology, various design factors should be considered at the same time, such as an energy density, a cycle life, a discharge capacity, a charge-discharge rate and other performance parameters. In addition, safety of the battery needs to be further considered.

There are many factors that affect the safety of the battery, and a short circuit of the battery is one of main factors that affect the safety of the battery. For embodiment, when in a short circuit, the battery may generate a extremely-high current and vast heat. The generated heat and excessively-strong electric energy release may seriously shorten the life of the battery, and even lead to explosion of a battery container due to an excessive pressure and a fire eventually.

In the case that a positive tab and a negative tab are led out of the same side of a cell 300, a cover assembly 200 of an existing battery generally includes a cover, a positive post and a negative post. The positive post and the negative post are separately arranged on the cover. An injection molded member is arranged between each of the positive post and the negative post and the cover, and the injection molded members isolate the positive post from the cover and isolate the negative post from the cover.

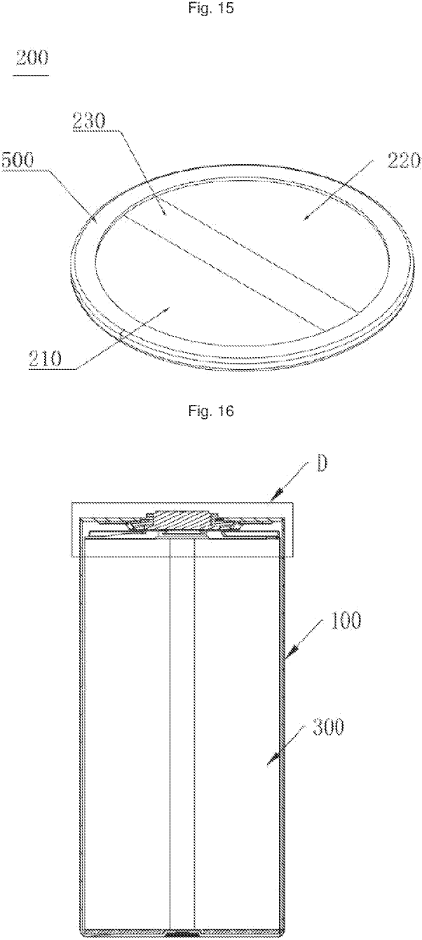

The inventor finds that an arrangement of the positive post and the negative post of the existing cover assembly 200 increases machining difficulty of the cover assembly 200, and the machining difficulty of the cover assembly 200 is high. In addition, the arrangement of the positive post and the negative post increases an overall height of the cover assembly 200, thus increasing a height space of the battery, and further reducing the energy density of the battery. Therefore, the inventor redesigns the cover assembly 200. With reference to FIG. 15, a designed cover assembly 200 includes a first cover 210, a second cover 220, and an insulator 230. The first cover 210 and the second cover 220 have opposite polarities, and the first cover 210 and the second cover 220 are connected to each other in an insulated manner through the insulator 230, thus effectively causing the cover assembly 200 to have different polarities, omitting machining of the post, improving machining efficiency of the cover assembly 200, and reducing cost.

However, the inventor finds that when the first cover 210 and the second cover 220 are connected to the corresponding tabs respectively, the first cover 210 and the second cover 220 are relatively close to each other, such that corresponding polarity tabs connected to the first cover and the second cover are relatively close to each other, the tabs having different polarities are likely to touch each other, and a short circuit of the battery is caused accordingly.

In view of this, the embodiment of the disclosure provides a technical solution. By arranging the insulating barrier 400 between two tabs with different polarities, the two tabs with different polarities are insulated from each other, thereby preventing the short circuit of the battery caused by probable contact between the tabs with different polarities during use, and effectively improve safety of the battery.

The technical solution described in the embodiment of the disclosure is applicable to a cylindrical battery and a battery module 800.

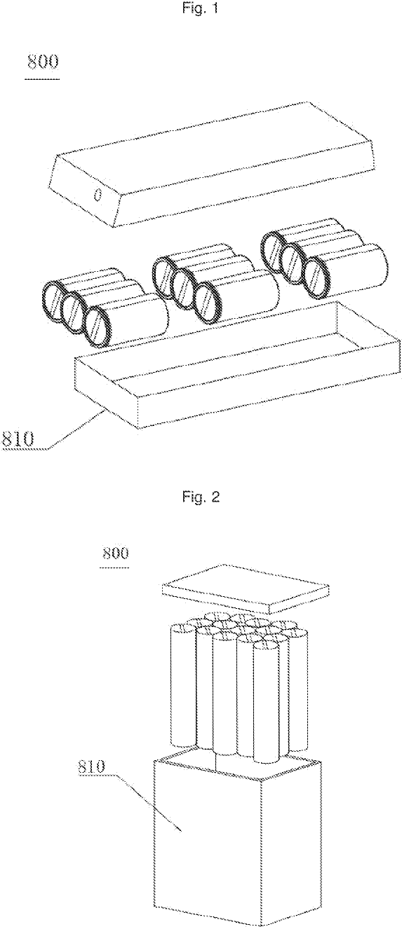

Some embodiments of the disclosure provide the battery module 800. With reference to FIGS. 1-2, the battery module 800 includes a box 810 and a battery, and the battery is accommodated in the box 810.

The box 810 is configured to accommodate the battery, and the box 810 has various structures. In some embodiments, the box 810 includes a first box portion and a second box portion. The first box portion and the second box portion mutually cover each other, and the first box portion and the second box portion jointly define an accommodation space for accommodating the battery. The second box portion is a hollowed structure with an open end, the first box portion is a plate-shaped structure, and the first box portion covers an open side of the second box portion to form the box 810 with an accommodation space. Each of the first box portion and the second box portion is a hollowed structure with an open side, and an open side of the first box portion covers an open side of the second box portion to form the box 810 with an accommodation space. It is certain that the first box portion and the second box portion have various shapes, such as a cylinder, a cuboid, etc.

In order to improve sealing performance after the first box portion and the second box portion are connected, a seal, such as a sealant and a seal ring, is arranged between the first box portion and the second box portion.

Assuming that the first box portion covers a top of the second box portion, the first box portion is called an upper box cover, and the second box portion is called a lower box.

For the battery, there are one or more batteries. If there are a plurality of batteries, the plurality of batteries are connected to one another in series, in parallel or in a parallel-series manner, and the parallel-series manner means that the plurality of batteries are connected in series and in parallel. The plurality of batteries are directly connected in series, in parallel or in a parallel-series manner, and then a whole formed by the plurality of batteries is accommodated in the box 810. It is certain that the plurality of batteries are connected in series, in parallel or in a parallel-series manner to form a battery block at first, and then a plurality of battery blocks are connected in series, in parallel or in a parallel-series manner to form a whole to be accommodated in the box 810.

In some embodiments, the plurality of batteries are arranged, and the plurality of batteries are connected in series, in parallel or in a parallel-series manner to form the battery block at first. Then the plurality of battery blocks are connected in series, in parallel or in a parallel-series manner to form a whole to be accommodated in the box 810.

The plurality of batteries in the battery module are electrically connected to one another through a bus component, so as to implement parallel connection, series connection or parallel-series connection of the plurality of batteries in the battery block.

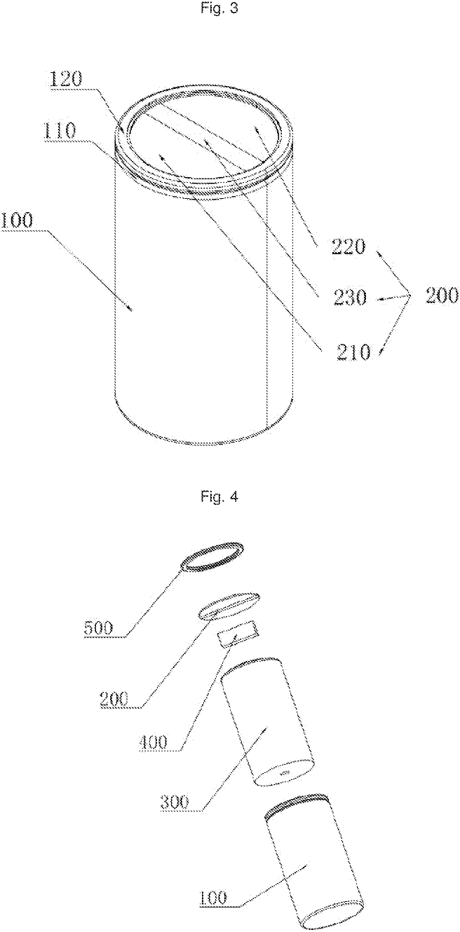

With reference to FIGS. 3-4, a cylindrical battery according to some embodiments of the disclosure includes: a housing 100; a cell 300 arranged in the housing 100, where the cell 300 is provided with a first tab 310, and a second tab 320 having an opposite polarity relative to the first tab 310, and the first tab 310 and the second tab 320 are located at the same end face of the cell 300; a cover assembly 200 connected to the housing 100, where the cover assembly 200 includes a first cover 210, a second cover 220 and an insulator 230, the first cover 210 and the second cover 220 are connected to each other in an insulated manner through the insulator 230 to form an integral structure, the first cover 210 is connected to the first tab 310, and the second cover 220 is connected to the second tab 320; and an insulating barrier 400 arranged between the first tab 310 and the second tab 320.

Compared with the related art, according to the cylindrical battery according to some embodiments of the disclosure, the housing 100, the cell 300, the cover assembly 200 and the insulating barrier 400 are used in cooperation, the cell 300 is provided with the first tab 310, and the second tab 320 having the opposite polarity relative to the first tab 310, the first tab 310 and the second tab 320 are located at the same end face of the cell 300, the cover assembly 200 includes the first cover 210, the second cover 220 and the insulator 230, the first cover 210 is connected to the first tab 310, the second cover 220 is connected to the second tab 320, the first cover 210 and the second cover 220 are connected to each other in an insulated manner through the insulator 230, the short circuit of the battery due to contact between the first tab 210 and the second tab 220 is effectively prevented, and the insulating barrier 400 is arranged between the first tab 310 and the second tab 320, thereby effectively isolating the first tab 310 from the second tab 320. The short circuit of the battery due to contact between the first tab 310 and the second tab 320 located at the same end face of the cell 300 is prevented, and safety of the battery is effectively improved.

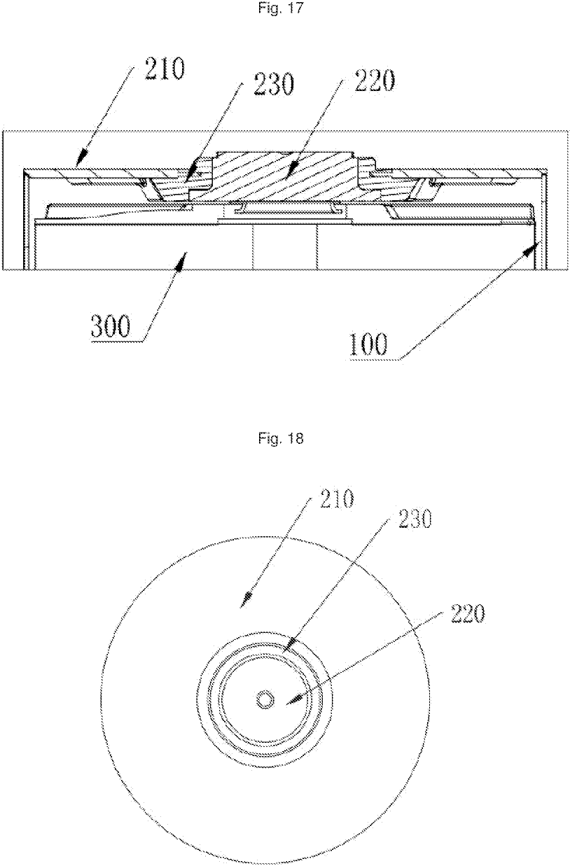

The cover assembly 200 of some embodiments of the disclosure is connected to the housing 100 in an insulated manner or connected to the housing 100 in a conductive manner. With reference to FIG. 3, Both the first cover 210 and the second cover 220 are in contact with the housing 100. In order to prevent a short circuit of the battery due to simultaneous conductive connection of the first cover 210 and the second cover 220 to the housing 100, it is necessary to connect each of the first cover 210 and the second cover 220 to the housing 100 in an insulated manner, that is, the cover assembly 200 is connected to the housing 100 in an insulated manner. With reference to FIGS. 16-18, the housing 100 is merely in contact with the first cover 210, and the first cover 210 is insulated from the second cover 220 by the insulator 230. The first cover 210, the insulator 230 and the second cover 220 are concentrically arranged, and the housing 100 is directly connected to the first cover 210 in a conductive manner without insulation.

The housing 100 of some embodiments of the disclosure is a hollowed structure with an open side, and the cover assembly 200 covers an open of the housing 100 in sealed insulation connection to form an accommodation cavity for accommodating the cell 300 and an electrolyte. Through the insulation connection between the housing 100 and the cover assembly 200, the short circuit of the battery due to the contact between the housing 100 and the cover assembly 200 is effectively prevented.

The housing 100 of the embodiment of the disclosure is a cylinder.

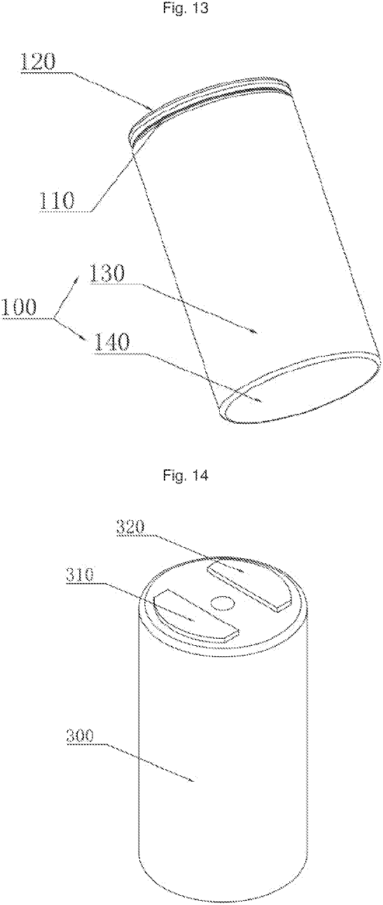

In an embodiment, with reference to FIG. 13, the housing 100 includes a side wall 130 and a bottom wall, the side wall 130 encircles an outer side of the cell 300, and a bottom wall is connected to an end of the side wall 130. The side wall 130 has a cylindrical structure, and the bottom wall has a plate-like structure, and has a shape corresponds to a shape of the side wall 130. Alternatively, one end of the side wall 130 forms an open, and the bottom wall is connected to the other end, facing away from the open, of the side wall 130.

The side wall 130 and the bottom wall has an integrally formed structure, that is, the housing 100 is an integrally formed member. It is certain that the side wall 130 and the bottom wall are two members arranged separately, and then connected together through welding, riveting, bonding, etc.

The side wall 130 includes a flange portion 110 formed at a lower portion of the cover assembly 200 and an inward bent crimping portion 120 formed at an upper portion of the cover assembly 200. Before compression sealing of the battery, the flange portion 110 needs to be provided on the side wall 130 of the housing 100 to prepare for the compression sealing of the battery. After compression sealing of the battery, the inwards bent crimping portion 120 of the upper portion of the cover assembly 200 is formed on the side wall 130 of the housing 100.

It should be noted that an explosion-proof valve of the disclosure is arranged at a bottom of the housing 100, and the explosion-proof valve is formed at the bottom of the housing 100 through laser etching or laser welding, and a pattern of laser etching is set as a camber, a triangle, a square, a trapezoid, an ellipse, a wavy line, etc., and is selected according to actual needs when in use.

With reference to FIG. 14, the cell 300 according to some embodiments of the disclosure includes a first electrode plate, a second electrode plate and a separator. The separator is arranged between the first electrode plate and the second electrode plate, and the first electrode plate, the separator and the second electrode plate are stacked or wound to form the cell 300, and the first tab 310 is arranged on the first electrode plate and the second tab 320 is arranged on the second electrode plate.

In the case that the first electrode plate or the second electrode plate is a positive electrode plate, the positive electrode plate includes a positive current collector and a positive active material layer, and a surface of the positive current collector is coated with the positive active material layer. The positive current collector includes a positive coated area and a positive tab connected to the positive coated area. The positive coated area is coated with the positive electrode active material layer, and the positive tab is not coated with the positive electrode active material layer. A lithium ion battery is taken as an embodiment, the positive current collector is made of aluminum, the positive active material layer includes a positive active material, and the positive active material is lithium cobalt oxide, lithium iron phosphate, ternary lithium, lithium manganate, etc. In the case that the first electrode plate or the second electrode plate is a negative electrode plate, the negative electrode plate includes a negative current collector and a negative active material layer, and a surface of the negative current collector is coated with the negative active material layer. The negative current collector includes a negative coated area and a negative tab connected to the negative coated area. The negative coated area is coated with the negative active material layer, and the negative tab is not coated with the negative active material layer. The negative current collector is made of copper, the negative active material layer includes a negative active material, and the negative active material is carbon, silicon, etc. The separator is made of polypropylene (PP), polyethylene (PE), etc.

It should be noted that the first tab 310 is directly or indirectly connected to the first cover 210, and the second tab 320 is directly or indirectly connected to the second cover 220. In the indirect connection, the first tab 310 is connected to the first cover 210 through a switching piece of the first tab 310, and the second tab 320 is connected to the second cover 220 through a switching piece of the second tab 320. The switching piece is made of the same material as or the different materials from the first cover 210, the second cover 220, the first tab 310 and the second tab 320.

It should be noted that at least one first tab 310 and at least one second tab 320 are arranged. In the case that the first tab 310 or second tab 320 is a positive electrode, the first tab 310 or the second tab 320 is made of aluminum. In the case that the first tab 310 or the second tab 320 is a negative electrode, the first tab 310 or the second tab 320 is made of copper, nickel plated brass or upper aluminum and lower copper.

It should be noted that the first tab 310 is welded on the first electrode plate, or the first tab 310 is directly die-cut on the first electrode plate. The second tab 320 is welded on the second electrode plate, or the second tab 320 is directly die-cut on the second electrode plate.

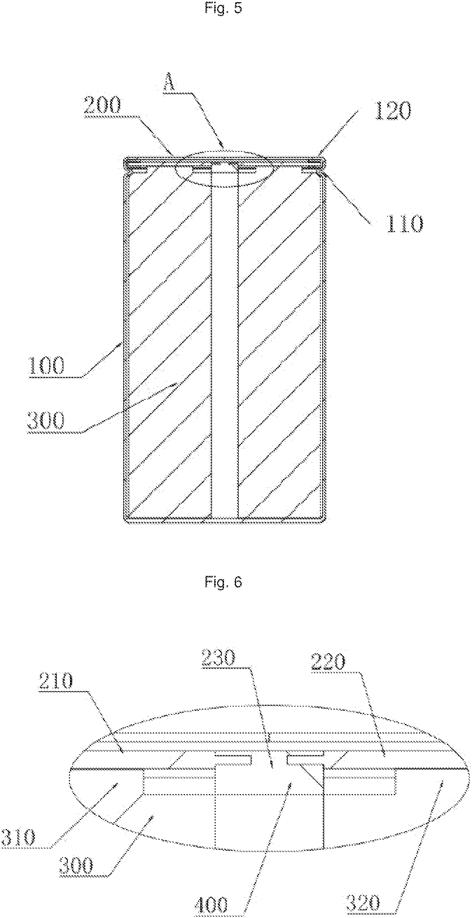

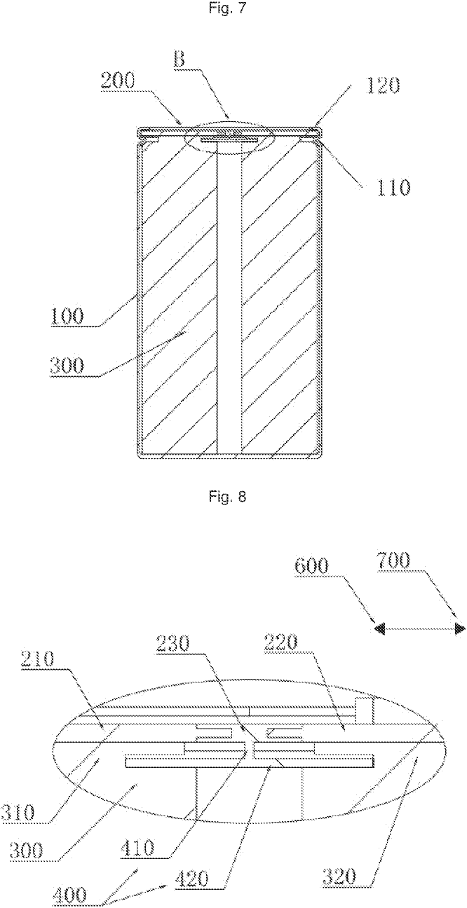

With reference to FIGS. 5 to 8, the insulating barrier 400 according to some embodiments of the disclosure includes a first connection portion 410 and a second connection portion 420, the first connection portion 410 is arranged perpendicular to the second connection portion 420, one end of the first connection portion 410 is connected to the second connection portion 420, one end of the second connection portion 420 extends in the x direction 600 towards the first tab 310 to form a space for accommodating the first tab 310, and the other end of the second connection portion 420 extends in the y direction 700 towards the second tab 320 to form a space accommodating the second tab 320. Through arrangement of the first connection portion 410 and the second connection portion 420, the first connection portion 410 is arranged perpendicular to the second connection portion 420, the first connection portion 410 is used for isolating the first tab 310 from the second tab 320, so as to prevent a short circuit of the battery due to contact between the first tab 310 and the second tab 320. One end of the second connection portion 420 extends in the X direction 600 towards the first tab 310 to form the space to accommodate the first tab 310, and the other end of the second connection portion 420 extends in the Y direction 700 towards the second tab 320 to form the space for accommodating the second tab 320, thereby preventing the short circuit of the cell 300 due to reverse insertion of the first tab 310 and the second tab 320 into the cell 300 by effectively restricting positions of the first tab 310 and the second tab 320. In addition, a bottom of the second connection portion 420 abuts against the cell 300, thus effectively restricting a position of the cell 300, and preventing the cell 300 from displacement.

The first connection portion 410 and the second connection portion 420 according to some embodiments of the disclosure are in a split structure or an integral structure. Through arrangement of the first connection portion 410 and the second connection portion 420, the first connection portion 410 and the second connection portion 420 are in a split structure or an integral structure. When the first connection portion 410 and the second connection portion 420 are in a split structure, the first connection portion 410 and the second connection portion 420 are fitted in the housing 100 in sequence, which is conducive to mounting of the first connection portion 410 and the second connection portion 420. When the first connection portion 410 and the second connection portion 420 are in an integral structure, the first connection portion 410 and the second connection portion 420 do not need to be machined separately, thus reducing machining cost and improving machining efficiency.

It should be noted that a plurality of tabs of the cell 300 generally use a bending process or a flattening process. Compared with the bending process, the flattening process has fewer cases in which the tabs are inserted reversely into the cell 300.

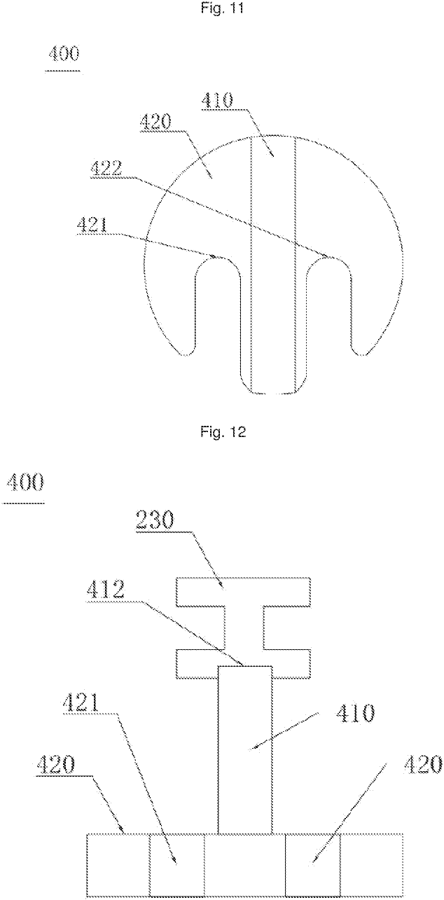

With reference to FIGS. 11-12, the second connection portion 420 according to some embodiments of the disclosure is provided with a first bayonet 421 and a second bayonet 422 on two sides of the first connection portion 410, the first tab 310 is in clamped connection to the first bayonet 421, and the second tab 320 is in clamped connection to the second bayonet 422. Through arrangement of the first bayonet 421 and the second bayonet 422, the first tab 310 is in clamped connection to the first bayonet 421, and the second tab 320 is in clamped connection to the second bayonet 422, such that the first tab 310 is effectively clamped by the first bayonet 421, the second tab 320 is effectively clamped by the second bayonet 422, and the short circuit of the battery due to reverse insertion of loose portions of the first tab 310 and the second tab 320 into the cell 300 in the case of looseness of the first tab 310 and the second tab 320 is prevented.

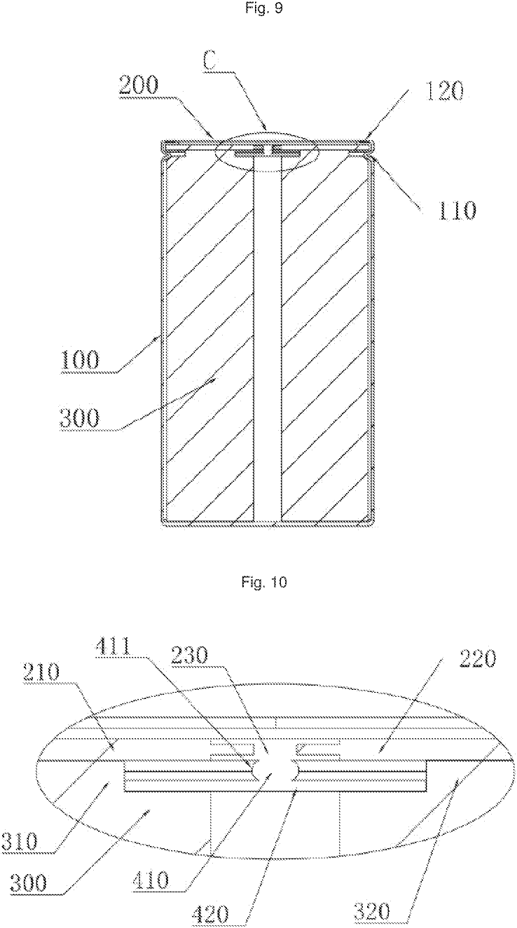

With reference to FIGS. 9-10, two ends of the first connection portion 410 according to some embodiments of the disclosure are provided with reinforcement structures 411. Through arrangement of the reinforcement structures 411, the reinforcement structures 411 are arranged at two ends of the first connection portion 410 to improve a structural strength of the first connection portion 410. In addition, the reinforcement structures 411 may effectively prevent the short circuit of the battery due to contact between the first tab 310 and the second tab 320, and improve isolation effects of the second connection portion 420 on the first tab 310 and the second tab 320.

The reinforcement structure 411 according to some embodiments of the disclosure is arranged in a cambered shape. By arranging the reinforcement structure 411 as a cambered-shaped portion, the cambered-shaped reinforcement structure 411 may effectively cushion the first tab 310 and the second tab 320 when abutting against the first tab 310 and the second tab 320, thus effectively protecting the first tab 310 and the second tab 320.

The second connection portion 420 according to some embodiments of the disclosure is made of a high-temperature resistant material. The second connection portion 420 is made of the high-temperature resistant material, such that the condition that safety performance of the battery is affected by ignition of the second connection portion 420 due to a low ignition point in the case of a high battery temperature is prevented.

A bottom of the insulator 230 according to some embodiments of the disclosure is provided with an accommodation groove 412, and the other end of the first connection portion 410 is arranged in the accommodation groove 412. Through arrangement of the accommodation groove 412, the accommodation groove 412 is located at the bottom of the insulator 230, and the other end of the first connection portion 410 is arranged in the accommodation groove 412, thus effectively connecting the first connection portion 410 to the insulator 230, restricting the position of the first connection portion 410, and preventing the first connection portion 410 from sliding in the housing 100.

It should be noted that a cross-sectional shape of the accommodation groove 412 is one of a circle, a square, a triangle, a trapezoid, a pentagon and a hexagon. A connection strength between the accommodation groove 412 in a circle, a trapezoid, a pentagon and a hexagon and the first connection portion 410 is better than a connection strength between the accommodation groove 412 in a square or a triangle and the first connection portion. The shape is set according to actual needs in use.

It should be noted that connection modes between the first connection portion 410 and the accommodation groove 412 include, but are not limited to, bonding, riveting, bolting and clamping.

The insulator 230 according to some embodiments of the disclosure and the first connection portion 410 are in an integral structure. The insulator 230 and the first connection portion 410 are arranged in an integral structure, the first connection portion 410 and the insulator 230 do not need to be machined separately, thus reducing the machining cost and improving the machining efficiency.

A surface, connected to the insulator 230, of the first cover 210 and/or the second cover 220 according to some embodiments of the disclosure is provided with a plurality of nanopores, and the insulator 230 is partially embedded in the plurality of nanopores. Through arrangement of the nanopores, the nanopores are provided on the surface, connected to the insulator 230, of the first cover 210 and/or the second cover 220, and the insulator 230 is partially embedded in the nanopores, such that bonding force between the first cover 210 and the insulator 230 and between the second cover 220 and the insulator are improved, desirable air tightness of joints between the first cover 210 and the insulator 230 and between the second cover 220 and the insulator are ensured, and the air tightness of the battery is improved.

It should be noted that the pore size and depth of the nanopore, and the distance between two adjacent pores is adjusted according to actual demand.

It should be noted that the first cover 210 and/or the second cover 220 according to the disclosure may form the plurality of nanopores through laser engraving or chemical etching. In addition, compared with usual chemical etching treatment, laser engraving is faster in pore forming rate, more efficient and more environmentally friendly, and a form, a pore diameter, a pore distribution density, etc. of the nanopores required is obtained by adjusting engraving parameters. Further, the insulator 230 is made of one of PP, PE and polyphenylene sulfite (PPS).

An insulating seal 500 is provided between the housing 100 and the cover assembly 200 according to some embodiments of the disclosure. The insulating seal 500 is arranged, such that the housing 100 is effectively insulated from the cover assembly 200, a sealing effect between the housing 100 and the cover assembly 200 is enhanced, and the battery is prevented from leaking.

Further, the insulating seal 500 and the insulator 230 are integrally formed. In the case that the insulating seal 500 and the insulator 230 are integrally formed, a space for mounting the first cover 210 and the second cover 220 needs to be reserved between the insulating seal 500 and the insulator 230, so as to guarantee subsequent connection between the first tab 310 and the first cover 210 and subsequent connection between the second tab 320 and the second cover 220.

It should be noted that surfaces, connected to the insulating seal 500, of the housing 100 and the cover assembly 200 is sealed through nano-processing, or the insulating seal 500 is bonded between the housing 100 and the cover assembly 200 for sealing. in addition, after nano-processing, bonding strengths between the housing 100 and the insulating seal 500 and between the cover assembly 200 and the insulating seal is effectively improved, and the air tightness between the housing 100 and the cover assembly 200 is further improved.

For those skilled in the art, it is apparent that the disclosure is not limited to the details of the above exemplary embodiments, and the disclosure may be implemented in other specific forms without departing from the spirit or basic features of the disclosure. Therefore, for all intents and purposes, the embodiments should all be regarded as exemplary and non-limiting. The scope of the disclosure is defined by the appended xclaims rather than the above description, and therefore it is intended that all changes falling within the meanings and scope of equivalent elements of the claims are included in the disclosure.

What is claimed is:

1. A cylindrical battery, comprising:
a housing;
a cell arranged in the housing, wherein the cell is provided with a first tab, and a second tab having an opposite polarity relative to the first tab, and the first tab and the second tab are located at the same end face of the cell;
a cover assembly connected to the housing, wherein the cover assembly comprises a first cover, a second cover and an insulator, the first cover and the second cover are connected to each other in an insulated manner through the insulator to form an integral structure, the first cover is connected to the first tab, and the second cover is connected to the second tab; and
an insulating barrier arranged between the first tab and the second tab.

2. The cylindrical battery according to claim 1, wherein the insulating barrier comprises a first connection portion and a second connection portion, the first connection portion is arranged perpendicular to the second connection portion, one end of the first connection portion is connected to the second connection portion, one end of the second connection portion extends in the x direction towards the first tab to form a space for accommodating the first tab, and the other end of the second connection portion extends in the y direction towards the second tab to form a space accommodating the second tab.

3. The cylindrical battery according to claim 2, wherein the second connection portion is provided with a first bayonet and a second bayonet on two sides of the first connection portion, the first tab is in clamped connection to the first bayonet, and the second tab is in clamped connection to the second bayonet.

4. The cylindrical battery according to claim 2, wherein the second connection portion is made of a high-temperature resistant material.

5. The cylindrical battery according to claim 2, wherein two ends of the first connection portion are provided with reinforcement structures.

6. The cylindrical battery according to claim 5, wherein each of the reinforcement structures is arranged in a cambered shape.

7. The cylindrical battery according to claim 2, wherein the first connection portion and the second connection portion are in a split structure or an integral structure.

8. The cylindrical battery according to claim 2, wherein the bottom of the insulator is provided with an accommodation groove, and the other end of the first connection portion is arranged in the accommodation groove.

9. The cylindrical battery according to claim 8, wherein the insulator and the first connection portion are in an integral structure.

10. The cylindrical battery according to claim 1, wherein a surface, connected to the insulator, of the first cover and/or the second cover is provided with a plurality of nanopores, and the insulator is partially embedded in the plurality of nanopores.

11. The cylindrical battery according to claim 1, wherein an insulating seal is arranged between the housing and the cover assembly.

12. The cylindrical battery according to claim 11, wherein the insulating seal and the insulator are integrally formed.

13. A battery module, comprising a plurality of cylindrical batteries according to claim 1.

14. The battery module according to claim 13, wherein the insulating barrier comprises a first connection portion and a second connection portion, the first connection portion is arranged perpendicular to the second connection portion, one end of the first connection portion is connected to the second connection portion, one end of the second connection portion extends in the x direction towards the first tab to form a space for accommodating the first tab, and the other end of the second connection portion extends in the y direction towards the second tab to form a space accommodating the second tab.

15. The battery module according to claim 14, wherein the second connection portion is provided with a first bayonet and a second bayonet on two sides of the first connection portion, the first tab is in clamped connection to the first bayonet, and the second tab is in clamped connection to the second bayonet.

16. The battery module according to claim 14, wherein the second connection portion is made of a high-temperature resistant material.

17. The battery module according to claim 14, wherein two ends of the first connection portion are provided with reinforcement structures.

18. The battery module according to claim 17, wherein each of the reinforcement structures is arranged in a cambered shape.

19. The battery module according to claim 14, wherein the first connection portion and the second connection portion are in a split structure or an integral structure.

20. The battery module according to claim 14, wherein the bottom of the insulator is provided with an accommodation groove, and the other end of the first connection portion is arranged in the accommodation groove.
